(19) United States
(12) Patent Application Publication
(10) Pub. No.: US 2010/0170358 A1
(43) Pub. Date: Jul. 8, 2010

(54) DRIVE TRANSMISSION DEVICE, DEVELOPMENT DEVICE PROVIDED THEREWITH, AND IMAGE FORMING APPARATUS

(75) Inventor: Tatsuya Kobayashi, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Kyocera Mita Corporation, Osaka (JP)

(21) Appl. No.: 12/570,546

(22) Filed: Sep. 30, 2009

(30) Foreign Application Priority Data
Jan. 7, 2009 (JP) 2009-001342

(51) Int. Cl. F16H 3/20

(52) U.S. Cl. 74/339

(57) ABSTRACT

A drive transmission device includes a first gear for drive input, arranged in a development unit of an image forming apparatus, a third gear for driving a development roller and a magnetic roller, and a second gear transmitting rotation of the first gear to the third gear. A phase in a circumferential direction of a first gear portion and a second gear portion is adjusted so that an angle formed between an engagement point between the first gear and the first gear portion and an engagement point between the second gear portion and the third gear is substantially identical to a fixed angle formed by centerlines drawn between the rotational axis of the second gear and the rotational axes of the first and the third gears.

### INCORPORATION BY REFERENCE

This application is based upon and claims the benefit of priority from the corresponding Japanese Patent Application No. 2009-001342 filed Jan. 7, 2009, the entire contents of which are incorporated herein by reference.

### BACKGROUND OF THE INVENTION

1. Field of the Invention

The present invention relates to a drive transmission device with which gears for transmitting a drive have been coupled and an image forming apparatus utilizing the drive transmission device.

2. Description of the Related Art

Conventionally, in image forming apparatuses such as copying machines, printers, or facsimile machines, a variety of rotary members are used. In order to rotate such rotary members, there is a need to transmit a drive from a drive source such as a drive motor to each of the rotary members. Therefore, multi-stepped gears are arranged in order to increase a speed reducing ratio from a gear coupled with a drive motor rotating at a high speed, causing a rotation speed to be reduced until the transmitted drive reaches each of the rotary members.

In such a drive transmission device, for example in a case where three or more gears are engaged to transmit a drive, if gear engagement fails, vibration could occur or an image non-uniformity, such as an irregularity in image density, could occur.

Therefore, methods for eliminating gear engagement failures have been proposed. For example, a first example discloses a method of forming resin-molded two-stepped gears concentrically having a follower-side large gear and a drive-side small gear. Such a resin-molding process can result in non-uniform tooth spacing, leaving a dense side (relatively thicker teeth with relatively smaller inter-tooth spacing) and a loose side (relatively thinner teeth with relatively larger inter-tooth spacing), which can lead to an engagement pitch error. In such a circumstance, a dense side (or a loose side) of the drive-side small gear will be engaged when the loose side (or the dense side) of the follower-side large gear is engaged. This method purportedly balances out rotation non-uniformity occurring from the follower-side large gear side and rotation non-uniformity occurring from the drive-side small gear side, which reduces rotation non-uniformity at a low cost, even lacking high die precision or management precision at the time of molding. This reduces rotation non-uniformity of a rotary drum.

A second example discloses a method of selecting Z (the number of teeth of a drive gear coaxially fixed to a shaft of a photosensitive drum) and θ (an angle of a photosensor from a write position to a transfer position of the photosensitive drum) so that Z*θ/360 degrees is an integer. As a result, a speed change at the time of writing is in phase with a speed change at the time of transfer of a written image. Furthermore, a transferred image free of jitter can be obtained while a tooth form or precision of gears or the like in a drive system of the photosensitive drum is kept as is. Finally, color tone non-uniformity exerted by jitter in color image forming is eliminated.

Further, a third example discloses a method of providing means for limiting movement of two coaxial gears in a circumferential direction, in order to prevent displacement of the two gears with respect to one another and to facilitate engagement of the gears with another gear. The gears are backlash-free gears, in which a spring is capable of displacing two driving-axle gears engaged with a single gear.

Furthermore, a fourth example discloses a method of forming interlock gears in which a plurality of gears are coaxially arranged. The gears adjacent to each other have coupling means capable of performing transmission and coupling by a predetermined rotation angle, thereby enabling phase alignment by each of the gears constituting the interlock gears and enabling phase alignment of the entire gear drive train.

However, the first example merely discloses aligning a looseness or denseness of engagements at the drive-side and at the follower-side, and fails to disclose a method of adjusting engagement according to a positional relationship between a plurality of gears. In addition, the second example does not relate to engagement between gears, and moreover, merely suggests a relationship between a write position and a transfer position in one photosensitive drum. The third example is for facilitating engagement of backlash-free gears, and does not relate to engagement of a plurality of gears. Further, in the fourth example, the phase in the gears of two-stepped gears is adjusted by coupling an engagement protrusion portion and an engagement recessed portion, thus making it difficult to precisely perform phase alignment.

Therefore, considering any three gears, for example, gear engagement has not been designed to make simultaneous a moment for a gear disposed at a center to deliver a drive to one gear and a moment of delivering the drive to the other gear according to a positional relationship among three gears. In particular, gears are engaged in a state in which the smaller the number of teeth is, the greater the teeth pitch intervals are, and vibration is prone to occur significantly.

The present invention has been made in view of the above-described problem, and aims to provide a drive transmission device and an image forming apparatus provided therewith, which are capable of eliminating failures concerning engagement between gears and reducing vibration.

### SUMMARY OF THE INVENTION

In order to achieve the above-described object, the present invention is for transmitting a drive. A drive transmission device according to one aspect of the present invention uses a gear train to transmit the drive. The device comprises a first gear, a second gear coupled with the first gear, and a third gear coupled with the second gear. The first, second, and third gears are disposed in a predetermined positional relationship. The second gear has a first gear portion to be coupled with the first gear and a second gear portion coupled with the third gear, and is constituted to coaxially integrally rotate. A phase between the first gear portion and the second gear portion in a circumferential direction is adjusted so that an angle formed between an engagement point between the first gear and the first gear portion and an engagement point between the second gear portion and the third gear becomes substantially identical to an angle formed between a centerline connecting the first gear and the second gear to each other and a centerline connecting the second gear and the third gear.

In addition, a drive transmission device according to another aspect of the present invention is directed to a drive transmission device for transmitting a drive by gear train, the device comprising: a first gear; a second gear coupled with the first gear; and a third gear coupled with the second gear, wherein: the first, second, and third gears are disposed in a predetermined positional relationship; the second gear is made of a helical one-stepped gear; and an interval between an engagement position between the first gear and the second gear in a thrust direction and an engagement position between the second gear and the third gear is adjusted so that an angle formed between an engagement point between the first gear and the second gear and an engagement point between the second gear and the third gear becomes substantially identical to an angle formed between a centerline connecting the first gear and the second gear to each other and a centerline connecting the second gear and the third gear to each other.

Additional features and advantages are described herein, and will be apparent from the following Detailed Description and the figures.

### DESCRIPTION OF THE DRAWINGS

FIG. 1 is a schematic diagram showing a configuration of a tandem-type color image forming apparatus in which a drive transmission device according to a first embodiment of the present invention is incorporated;

FIG. 2 is a perspective view showing a disposition/configuration of the drive transmission device of the embodiment;

FIG. 3 is a front view showing the disposition/configuration of the drive transmission device of the embodiment;

FIG. 4 is a view seen from the upper left (the direction indicated by the arrow C of FIG. 3), showing a state of engagement of a drive input gear and a drive output gear with respect to an idle gear in the drive transmission device according to the first embodiment of the present invention;

FIG. 5 is a view showing a relationship between an engagement position and a pitch angle in a circumferential direction of the drive input gear and the drive output gear with respect to a second gear portion;

FIG. 6 is a view showing an engagement relationship between an engagement point between the drive input gear and the idle gear and an engagement point between the idle gear and the drive output gear;

FIG. 7 is a view showing a state in which a phase of a second gear portion is adjusted;

FIG. 8 is a view seen from the upper left (the same direction as that indicated by the arrow in FIG. 4), showing a state of engagement between a drive input gear and a drive output gear with respect to an idle gear in a drive transmission device according to a second embodiment of the present invention;

FIG. 9 is a view showing a disposition relationship in a thrust direction of an engagement point between the second gear portion and the drive output gear of FIG. 8;

FIG. 10 is a view showing a state in which a phase of the second gear portion is adjusted;

FIG. 11 is a view seen from the upper left (the same direction as that indicated by the arrow in FIG. 8), showing a state of engagement between a drive input gear and a drive output gear with respect to an idle gear in a drive transmission device according to a third embodiment of the present invention; and

FIG. 12 is a view showing an engagement position in a thrust direction of an engagement point between the idle gear and the drive output gear of FIG. 11.

### DESCRIPTION OF THE PREFERRED EMBODIMENTS

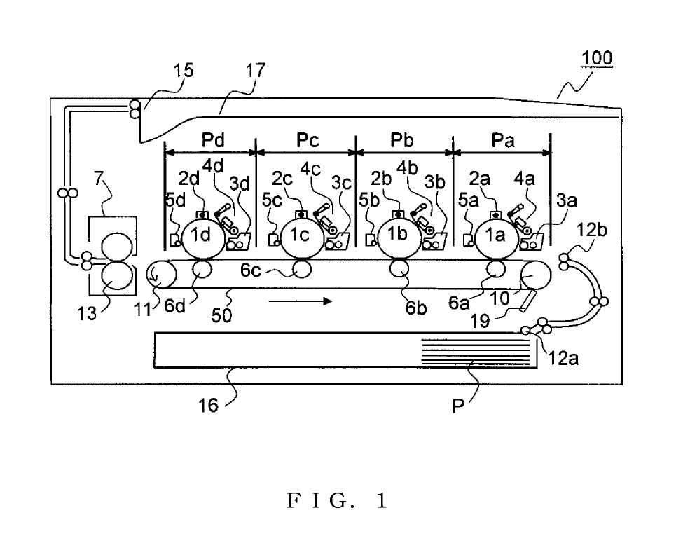

Hereinafter, embodiments of the present invention will be described in detail, with reference to the drawings. FIG. 1 is a schematic diagram showing a configuration of a tandem-type color image forming apparatus in which a drive transmission device according to a first embodiment of the present invention is incorporated. In a main body of an image forming apparatus 100, four image forming portions Pa, Pb, Pc, and Pd are arranged in sequential order from an upstream side in a transport direction (at the right side in FIG. 1). These image forming portions Pa to Pd are provided in correspondence with images of four different colors (black, magenta, cyan, and yellow), and sequentially form images of black, magenta, cyan, and yellow according to processes of electrification, exposure, development, and transfer.

At the image forming portions Pa to Pd, photosensitive drums (image carriers) 1a, 1b, 1c, and 1d for carrying visible images (toner images) of the colors are arranged and constituted so that: the toner images formed on these photosensitive drums 1a to 1d are sequentially transferred onto paper P transported by means of a transport belt 50 moving adjacent to each of the image forming portions while it is rotated in the counterclockwise direction (the same direction as that indicated by the arrow in FIG. 1) by drive means (not shown); are further fixed onto the paper P at a fixing portion 7; and thereafter, are ejected by means of the main body of the apparatus. With the photosensitive drums 1a to 1d being rotated clockwise in FIG. 1, an image forming process for each of the photosensitive drums 1a to 1d is executed.

The paper P onto which the toner images are to be transferred is accommodated in a paper cassette 16 at the lower part of the apparatus, and is transported to each of the image forming portions Pa to Pd via a paper feed roller 12a and a resist roller pair 12b. A dielectric resin-based sheet is employed for the transport belt 50, and a belt formed in an endless shape by superimposing and bonding flange portions thereof with each other or a seamless belt is employed. In addition, a cleaning blade 19 for removing the toner adhered to the transport belt 50 is disposed at the upstream side of a follower roller 10.

Next, the image forming portions Pa to Pd will be described. Those provided peripherally and upwardly of the photosensitive drums 1a to 1d rotatably arranged are: electrification devices 2a, 2b, 2c, and 2d for electrifying the photosensitive drums 1a to 1d; LED heads 4a, 4b, 4c, and 4d for individually exposing image information to the photosensitive drums 1a to 1d, respectively; development units 3a, 3b, 3c, and 3d for forming toner images on the photosensitive drums 1a to 1d; and cleaning portions 5a, 5b, 5c, and 5d for removing a development agent (toner) remaining on the photosensitive drums 1a to 1d.

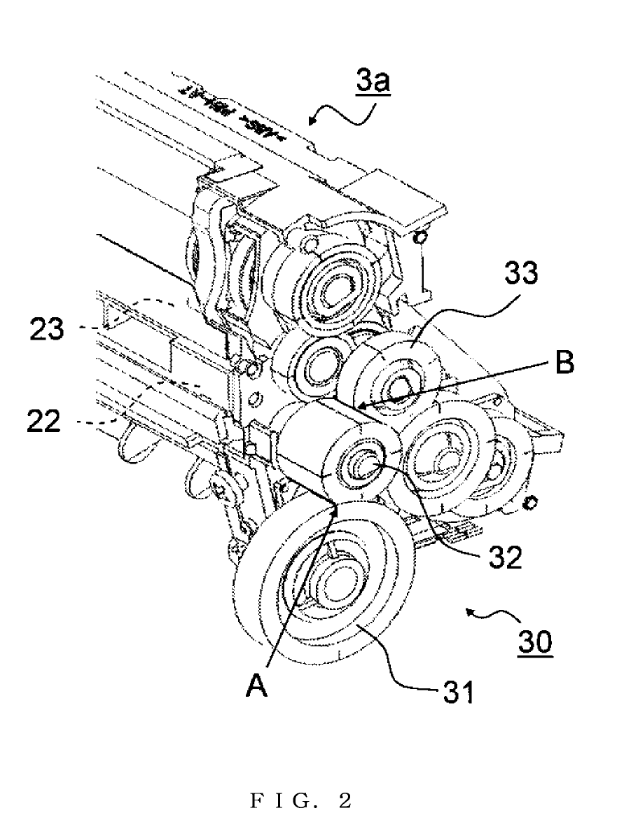

When a user initiates image forming, surfaces of the photosensitive drums 1a to 1d are first uniformly electrified by means of the electrification devices 2a to 2d; light is then emitted by means of the LED heads 4a to 4d; and an electrostatic latent image according to an image signal is formed on each of the photosensitive drums 1a to 1d. The development units 3a to 3d are provided with a development roller 22 (toner carrier) disposed oppositely, i.e., at an opposite side to the photosensitive drums 1a to 1d (see FIG. 2), and toner of colors black, magenta, cyan, and yellow, respectively, is filled in a predetermined quantity by means of a replenishing device (not shown).

This toner is a magnetic toner with positive polarity, for example, and is supplied onto the photosensitive drums 1a to 1d by means of development units 3a to 3d. It is adhered thereto in an electrostatic manner, whereby toner images according to electrostatic latent images formed by exposure from the LED heads 4a to 4d are formed. The photosensitive drums 1a to 1d and the development units 3a to 3d will be described later in detail.

After an electric field has been applied to the transport belt 50 at a predetermined transfer voltage, toner images of magenta, cyan, yellow, and black on the photosensitive drums 1a to 1d are transferred onto the paper P transported to the transport belt 50 by means of transfer rollers 6a to 6d. Images of these four colors are formed with a predetermined positional relationship for predetermined full-color image forming. Afterwards, the toner remaining on the surfaces of the photosensitive drums 1a to 1d is removed by means of the cleaning portions 5a to 5d, in preparation for subsequent formation of a new electrostatic latent image.

The transport belt 50 is hung on the follower roller 10 and a drive roller 11. If the transport belt 50 starts its rotation counterclockwise with rotation of the drive roller 11 by means of a drive motor (not shown), the paper P is transported from a resist roller pair 12b to the image forming portions Pa to Pd with a predetermined timing. Images are sequentially transferred onto the paper P at a nip portion with the transport belt 50 in each of the image forming portions, and a full-color image is formed. The paper to which a toner image is transferred is transported to a fixing portion 7.

The paper P transported to the fixing portion 7 is heated and pressed when the paper passes through a nip portion (a fixing nip portion) of a fixing roller pair 13. A toner image is fixed onto a surface of the paper P and a predetermined full-color image is formed. The paper P on which the full-color image is formed is ejected onto an ejection tray 17 by means of an ejection roller 15.

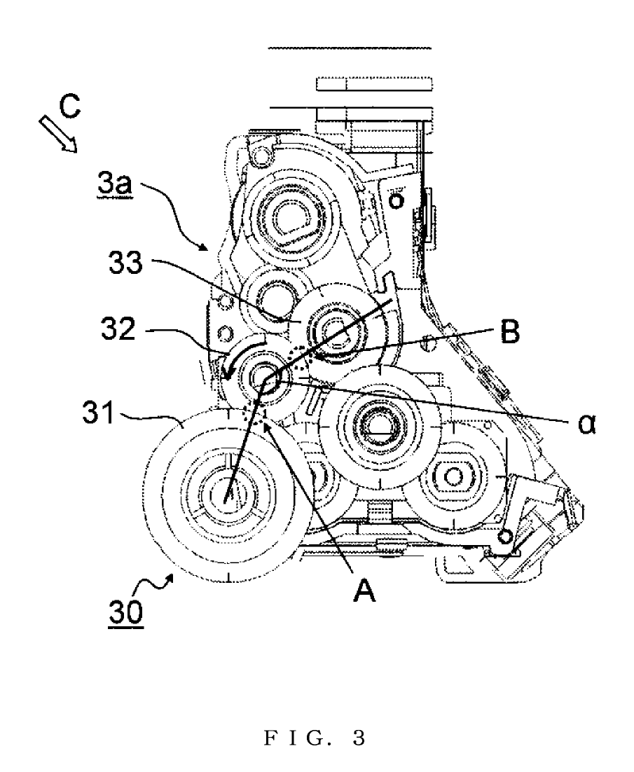

FIG. 2 is a perspective view showing a disposition/configuration of the drive transmission device of the embodiment, and FIG. 3 is a front view of the device. The configurations of the photosensitive drums 1a to 1d and the development units 3a to 3d in colors, i.e., cyan, magenta, yellow, and black are preferably completely identical to each other, and thus, FIGS. 2 and 3 show only the photosensitive drum 1a and the development unit 3a. Hereinafter, a drive transmission device 30 applied to the photosensitive drum 1a and the development unit 3a will be described.

As shown in FIGS. 2 and 3, at the development unit 3a are the aforementioned development roller 22 and a magnetic roller (toner supply member) 23 disposed oppositely, i.e., at an opposite side to the photosensitive drum 1a with respect to the development roller 22. A toner is adhered by means of a magnetic force on a surface of the magnetic roller 23.

In addition, with respect to the photosensitive drum 1a rotating clockwise in the figure, the development roller 22 rotates counterclockwise, and the magnetic roller 23 rotates clockwise. Further, the photosensitive drum 1a and the development unit 3a are disposed at their predetermined positions according to the specification of the main body of the apparatus. The development roller 22 and the magnetic roller 23 are also disposed at their predetermined positions in the development unit 3a.

When the magnetic roller 23, the development roller 22, and the photosensitive drum 1a rotate, if a bias is applied to the magnetic roller 23 and the development roller 22 from a power source (not shown), the toner adhered to a surface of the magnetic roller 23 in the development unit 3a moves onto a surface of the development roller 22 due to a potential difference between the magnetic roller 23 and the development roller 22. The toner adhered to the surface of the development roller 22 is moved to a surface of the photosensitive drum 1a due to a potential difference between the development roller 22 and the photosensitive drum 1a. In this manner, a toner image is formed on the photosensitive drum 1a, as described previously.

A drive is transmitted to the development roller 22 and the magnetic roller 23 by means of the drive transmission device 30. The drive transmission device 30 is provided with a drive input gear (first gear) 31, an idle gear (second gear) 32, and a drive output gear (third gear) 33 for rotationally driving the development roller 22 and the magnetic roller 23. The drive from a drive motor (not shown) is transmitted via the drive input gear 31.

In addition, the idle gear 32 is coupled with the drive input gear 31 and the drive output gear 33. The drive input gear 31, the idle gear 32, and the drive output gear 33 are formed of a resin material or a metal material, for example.

When the drive input gear 31 rotates clockwise in the figure, the idle gear 32 to which a drive is transmitted from the drive input gear 31 rotates counterclockwise. When the idle gear 32 rotates counterclockwise, the drive output gear 33 to which a drive is transmitted from the idle gear 32 rotates clockwise. In this manner, the drive accepted by the drive input gear 31 is transmitted to the drive output gear 33 via the idle gear 32.

Here, as described above, the dispositions of the development roller 22 and the magnetic roller 23 are predetermined, and thus, according to the predetermined dispositions, the dispositions of the drive input gear 31, the idle gear 32, and the drive output gear 33 are also determined. Such a positional relationship, as shown in FIG. 3 for example, is determined so that a straight line (centerline) formed by connecting axial centers of the drive input gear 31 and the idle gear 32 to each other and a straight line (centerline) formed by connecting axial centers of the idle gear 32 and the drive output gear 33 to each other, form a predetermined disposition angle α (140 degrees, for example).

Therefore, the dispositions of the drive input gear 31, the idle gear 32, and the drive output gear 33 cannot be changed. Even though the positional relationship between the gears cannot be changed, the phase in the circumferential direction of the idle gear 32 is adapted to be set so that an angle formed between an engagement point between the drive input gear 31 and the idle gear 32 and an engagement point between the idle gear 32 and the drive output gear 33 are substantially identical to each other with respect to a positional relationship among three gears, i.e., an angle (disposition angle) α formed between a centerline between the drive input gear 31 and the idle gear 32 and a centerline connecting the idle gear 32 and the drive output gear 33. Hereinafter, a method of setting the phase of the idle gear 32 will be described.

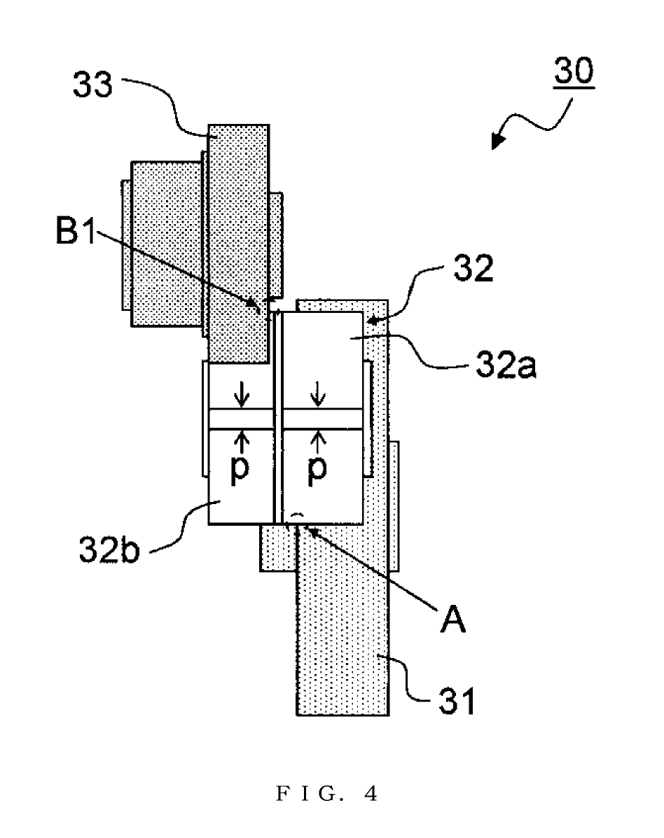

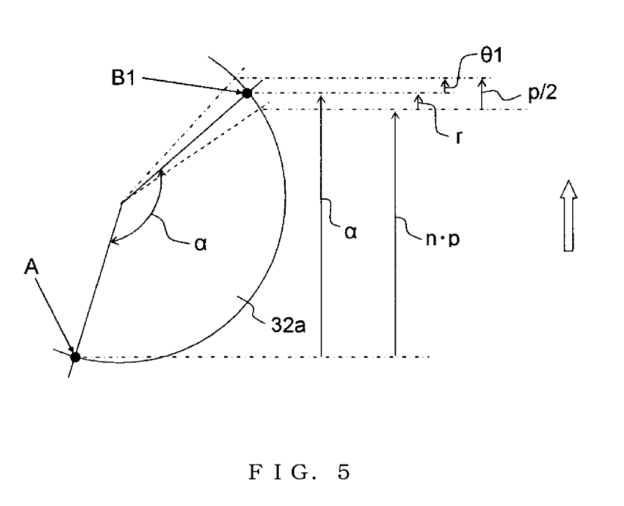

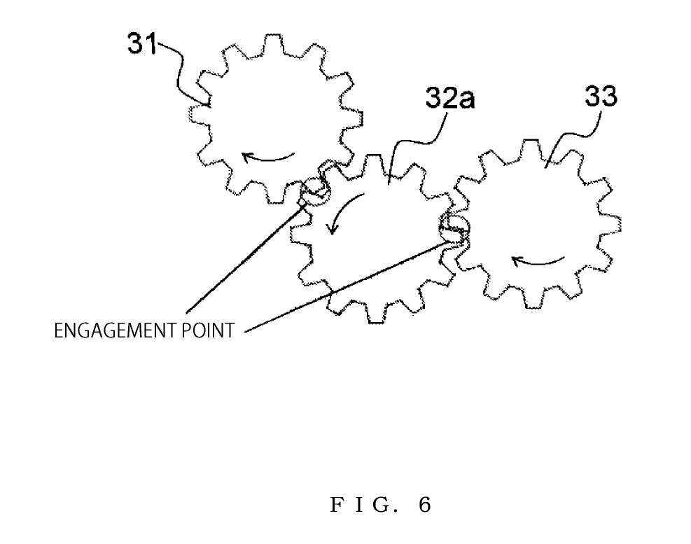

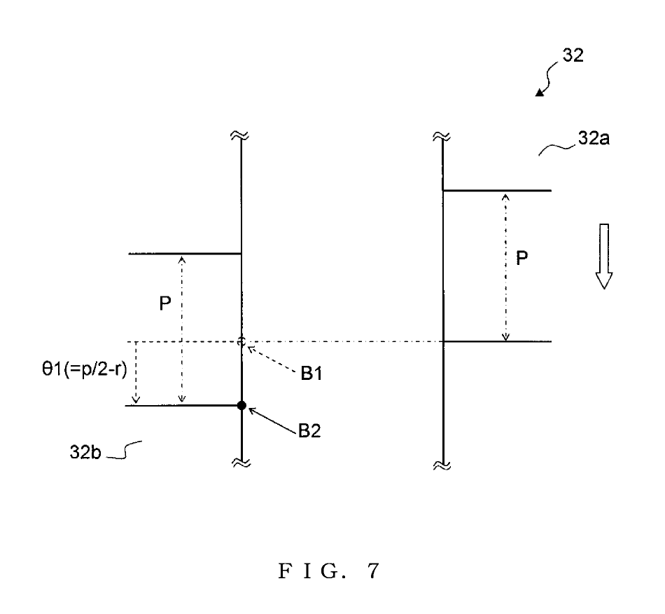

FIG. 4 is a view seen from the upper left (the direction indicated by the arrow C in FIG. 3), showing a state of engagement between a drive input gear and a drive output gear with respect to an idle gear in the drive transmission device according to the first embodiment of the present invention. FIG. 5 is a view showing a relationship between an engagement position and a pitch angle in a circumferential direction of the drive input gear and the drive output gear with respect to a second gear portion. FIG. 6 is a view showing an engagement relationship between an engagement point between the drive input gear and the idle gear and an engagement point between the idle gear and the drive output gear. Finally, FIG. 7 is a view showing a state in which a phase of a second gear portion is adjusted. Constituent elements common to those of FIGS. 2 and 3 are designated by common reference numerals, and a duplicate description thereof is omitted.

The drive input gear 31 is comprised of a spur-tooth one-stepped gear with 32 teeth and a pressure angle of 14.5 degrees; the drive output gear 33 is comprised of a spur-tooth one-stepped gear with 18 teeth and a pressure angle of 20 degrees; and the idle gear 32 is made of a spur-tooth two-stepped gear with 16 teeth. A diameter of a pitch circle of the idle gear 32 is set to R (13 mm herein).

The idle gear 32 is formed of: a first gear portion (first gear portion) 32a with a pressure angle 14.5 degrees, coupled with the drive input gear 31; and a second gear portion (second gear portion) 32b with a pressure angle of 20 degrees, coupled with the drive output gear 33. In addition, the idle gear 32 is integrally molded, so that the first and second gear portions 32a, 32b cannot rotate respectively independently.

As shown in FIG. 4, first, assume that the drive input gear 31 and the first gear portion 32a are engaged with each other at an engagement point A. For purposes of illustration, assume that the first gear portion 32a of the idle gear 32 is in phase with the second gear portion 32b. An engagement point between a right side end part of the drive output gear 33 and the second gear portion 32b is defined as B1.

A pitch angle p of the first gear portion 32a (360 degrees/16=22.5 degrees herein) can be computed from the number of teeth of the first gear portion 32a. At this time, assume that when the disposition angle α is divided by p, an integer n (6 herein) is obtained as the quantity of p included in the disposition angle α, and an angle r (5 degrees herein) is obtained as a surplus. The angle r represents a displacement angle on a pitch circle of the idle gear 32. In this case, as shown in FIG. 5, α is represented as α=n*p+r (6×22.5 degrees+5 degrees=140 degrees, herein).

In other words, the engagement point B1 is positioned at the downstream side by r with respect to n times of pitches p in the rotational direction of the idle gear 32 (in the outline arrow direction of FIG. 5). Therefore, in order to synchronize engagement at the engagement point A between the drive input gear 31 and the first gear portion 32a and the engagement point B1 between the second gear portion 32b and the drive output gear 33, there is a need to set the phase in the circumferential direction of the second gear portion 32b with respect to the first gear portion 32a to be advanced by r to the upstream side in the rotational direction of the idle gear 32 (indicated by the outline arrow in FIG. 5).

In addition, as shown in FIG. 6, a relationship is established such that, when the drive input gear 31 presses the upstream side in the rotational direction of a first tooth in the first gear portion 32a of the idle gear 32, the downstream side in the rotational direction of another tooth of the second gear portion 32b presses the upstream side in the rotational direction of an engagement tooth of the drive output gear 33. Therefore, there is a need to set the phase in the circumferential direction of the idle gear 32 so as to be moved by p/2 (22.5 degrees/2=11.25 degrees herein) with respect to n times of the pitch angle p. (α=p*(n−1)+p/2) at the downstream side in the rotational direction.

Therefore, a sum (p*n+p/2) between an integer multiple of the pitch angle p and ½ of the pitch angle p can be made identical to the disposition angle α by adjusting the phase in the circumferential direction of the second gear 32b with respect to the first gear portion 32a to be moved by a difference between p/2 and r, θ1(p/2−r), from the engagement point B1 to the downstream side in the rotational direction with respect to the integer multiple of the pitch angle p. The difference θ1 represents a displacement angle on a pitch circle of the idle gear 32.

Hence, as shown in FIG. 7, an angle formed between the engagement point A between the drive input gear 31 and the first gear portion 32a and the engagement point B2 between the second gear portion 32b and the drive output gear 33 can be made substantially identical to the disposition angle α by setting the phase in the circumferential direction of the second gear portion 32b so that the engagement point B1 between the second gear portion 32b and the drive output gear 33 is moved to an engagement point B2 which has been moved by θ1 to the downstream side in the rotational direction.

In this manner, a drive can be transmitted from the idle gear 32 to the drive output gear 33 at the engagement point B2 at a moment when a drive is transmitted from the drive input gear 31 to the idle gear 32 at the engagement point A. The idle gear 32 can be formed based upon the set phase.

According to the embodiment, even though the disposition angle α of the drive input gear 31, the idle gear 32, and the drive output gear 33 is fixed, and its positional relationship cannot be changed, the idle gear 32 in which the phase in the circumferential direction is adjusted according to the disposition angle α can be formed, thus making it possible to eliminate failures concerning engagement between gears and reduce vibration.

In addition, in this embodiment, the idle gear 32 was provided as a two-stepped gear integrally formed of: the first gear portion 32a to which the drive accepted by the drive input gear 31 is to be transmitted; and the second gear portion 32b for transmitting a drive to the drive output gear 33, and the angle formed between the engagement point A and the engagement point B2 was set to be substantially identical to the disposition angle α. In this manner, the phase of the idle gear 32 can be set in more detail, and thus, engagements among the drive input gear 31, the idle gear 32, and the drive output gear 33 can be adjusted in more detail for a beneficial effect.

However, the types, shapes, or the number of teeth, etc., of the drive input gear 31, the idle gear 32, and the drive output gear 33 may differ from what has been described with respect to the present embodiment. Other gears may be employed as long as the angle formed between the engagement point between the drive input gear 31 and the idle gear 32 and the engagement point between the idle gear 32 and the drive output gear 33 can be made identical to the disposition angle α. In addition, while the first and second gear portions 32a, 32b were integrally formed herein, their respective gears may also be combined after being formed independently, as long as they are integrally rotatable.

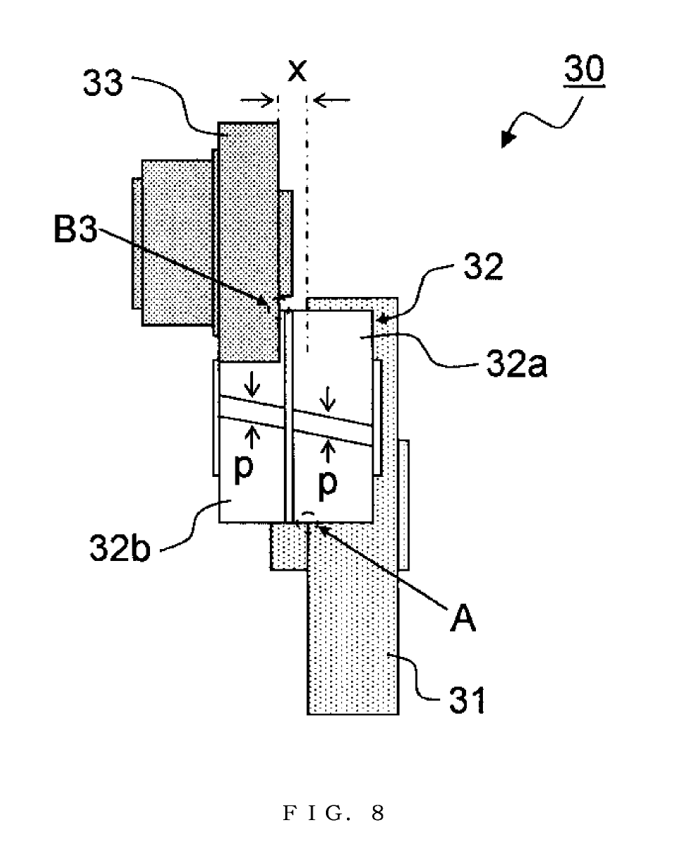

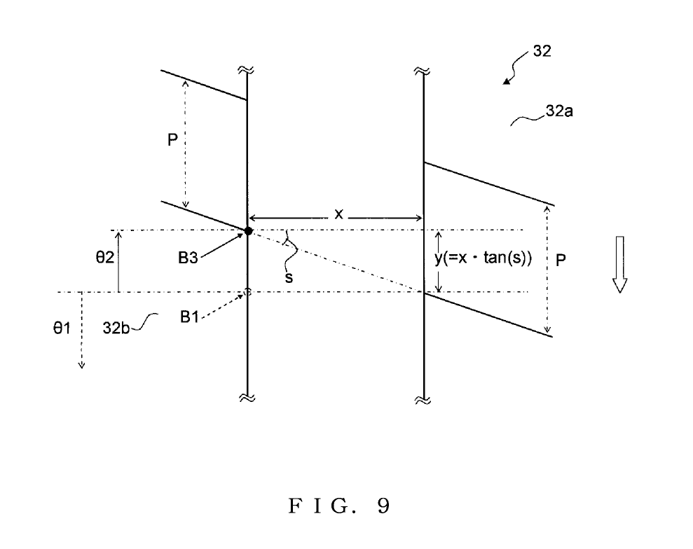

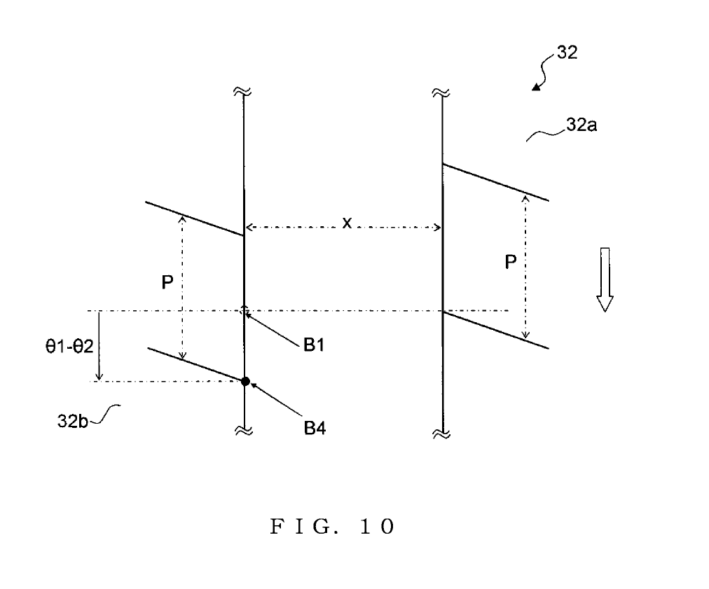

FIG. 8 is a view seen from the upper left (the same direction as that indicated by the arrow in FIG. 4), showing a state of engagement between a drive input gear and a drive output gear with respect to an idle gear in a drive transmission device according to a second embodiment of the present invention. FIG. 9 is a view showing a disposition relationship in a thrust direction of an engagement point between the second gear portion and the drive output gear of FIG. 8. FIG. 10 is a view showing a state in which a phase of the second gear portion is adjusted. Constituent elements common to those of FIGS. 4 and 7 are designated by like reference numerals, and a duplicate description is omitted.

In the second embodiment, the drive input gear 31 is comprised of a one-stepped helical gear with 32 teeth, a pressure angle of 14.5 degrees, and left torsion; the drive output gear 33 is comprised of a one-stepped helical gear with 18 teeth, a pressure angle of 20 degrees, and left torsion; and the idle gear 32 is comprised of a two-stepped helical gear with 16 teeth and right torsion.

The idle gear 32 is formed of: a first gear portion 32a with a pressure angle of 14.5 degrees, coupled with the drive input gear 31; and a second gear portion 32b with a pressure angle of 20 degrees, coupled with the drive output gear 33. In addition, a torsional angle of the first and second gear portions 32a, 32b is set to s (15 degrees herein).

In addition, an engagement point between the second gear portion 32b and the drive output gear 33 in a case where the first gear portion 32a and the second gear portion 32b are assumed to be in phase in a tooth trace direction is defined as B3 Further, an interval between the engagement point A and the engagement point B3 in a thrust direction (the transverse direction in the figure), i.e., a distance between a left side end part of the drive input gear 31 engaged with the first gear portion 32a and a right side end part of the drive output gear 33 engaged with the second gear portion 32b, is set to x (2 mm herein). Other constituent elements are similar to those of the first embodiment, and thus, a duplicate description is omitted.

In the embodiment, as shown in FIGS. 8 and 9, the tooth traces of the first and second gear portions 32a, 32b are inclined by an angle s with respect to the thrust direction (the transverse direction of the figures), so that the engagement positions in the circumferential directions of these gear portions are different from each other depending upon the engagement positions in the thrust directions of the drive input gear 31 and the drive output gear 33 with respect to the first and second gear portions 32a, 32b.

Therefore, in addition to the above-described first embodiment, the phase in the circumferential direction of the first and second gear portions 31a, 32b can be set based upon engagement positions of the engagement points A, B3 of the drive input gear 31 and the drive output gear 33 relative to the first and second gear portions 32a, 32b in the thrust direction. For the sake of simplicity of explanation, circumferential faces of the first and second gear portions 32a and 32b are assumed to be flattened.

First of all, as shown in FIG. 8, assume that the drive input gear 31 and the first gear portion 32a are engaged with each other at the engagement point A. At this time, assuming that the first gear portion 32a and the second gear portion 32b are in phase in the circumferential direction, a pitch point B2 of the second gear portion 32b advances by θ1 in a displacement angle from the engagement point B1 between the second gear portion 32b and the drive output gear 33 (see FIG. 5, FIG. 7), as in the first embodiment. Therefore, in the same manner as above, there is a need to set the phase in the circumferential direction of the second gear portion 32b to be moved by θ1 to the downward side (as indicated by the outline arrow of FIG. 9) in the rotational direction.

However, as shown in FIG. 9, the idle gear 32 is inclined by an angle s with respect to the thrust direction, so that an engagement point B3 in the circumferential direction of the second gear portion 32b with respect to the first gear portion 32a is displaced according to a difference in engagement position between the engagement point A and the engagement point B3 in the thrust direction. Accordingly, such a degree of displacement needs to be considered.

Here, a distance between the engagement point A and the engagement point B3 in the thrust direction is x (2 mm, herein), a displacement quantity y in the circumferential direction of the second gear portion 32b with respect to the first gear portion 32a is computed as x*tan(s) (2 mm*tan 15 degrees, herein) toward the upstream side in the rotational direction.

Hence, by employing such a displacement quantity y, a displacement angle θ2 of the engagement point B3 with respect to the abovementioned engagement point A can be computed as y*360 degrees/2πR (θ2=2 mm*tan 15 degrees*360 degrees(2π*13 mm) herein). θ2 designates a displacement angle on a pitch circle of the idle gear 32.

In this manner, the displacement angle θ2 of the engagement point B3 with respect to the engagement point B1 can be computed from the displacement quantity x and the torsional angle s in the thrust direction between the engagement point A and the engagement point B3.

By employing such a computation result, as shown in FIG. 9, there is a need to set the phase in the circumferential direction of the second gear portion 32b to be moved by the displacement angle θ2 to the upstream side in the rotational direction from the engagement point B1 to the engagement point B3.

Accordingly, the displacement angle in the circumferential direction of the second gear portion 32b can be computed as θ1−θ2 at the downstream side in the rotational direction. Even if the tooth traces of the first and second gear portions 32a, 32b are inclined by an angle −s with respect to the thrust direction, θ1−θ2 can be computed similarly.

Hence, as shown in FIG. 10, the phase in the circumferential direction of the second gear portion 32b is moved by θ1−θ2 to the downstream side in the rotational direction with respect to an integer multiple of a pitch angle p from the engagement point A. Furthermore, an engagement point between the second gear portion 32b and the drive output gear 33 is set as B4 (n*p+θ1−θ2), whereby an angle formed between the engagement point A between the drive input gear 31 and the first gear portion 32a and the engagement point B4 between the second gear portion 32b and the drive output gear 33 can be made substantially identical to the disposition angle α.

After the phase in the circumferential direction has been thus set, the idle gear 32 can be formed by integrally molding the first gear portion 32a and the second gear portion 32b. Here, calculation of the displacement angle θ1−θ2 of the second gear portion 32b was performed, assuming that the drive input gear 31 and the first gear portion 32a are engaged with each other at the engagement point A. Conversely, it is of course possible to compute a displacement angle of the first gear portion 32a, assuming that the second gear portion 32b engages with the drive output gear 33 at the engagement point B3 in the same manner as above.

In this embodiment, the drive input gear 31, the idle gear 32, and the drive output gear 33 comprised helical gears, and the phase in the circumferential direction of the first and second gear portions 32a, 32b was set based upon the engagement position between the drive input gear 31 and the first gear portion 32a in the thrust direction and the drive output gear 33 and the second gear portion 32b. This allows the engagement among the drive input gear 31, the idle gear 32, and the drive output gear 33 to be adjusted in more detail. In addition, vibration also can be reduced considerably.

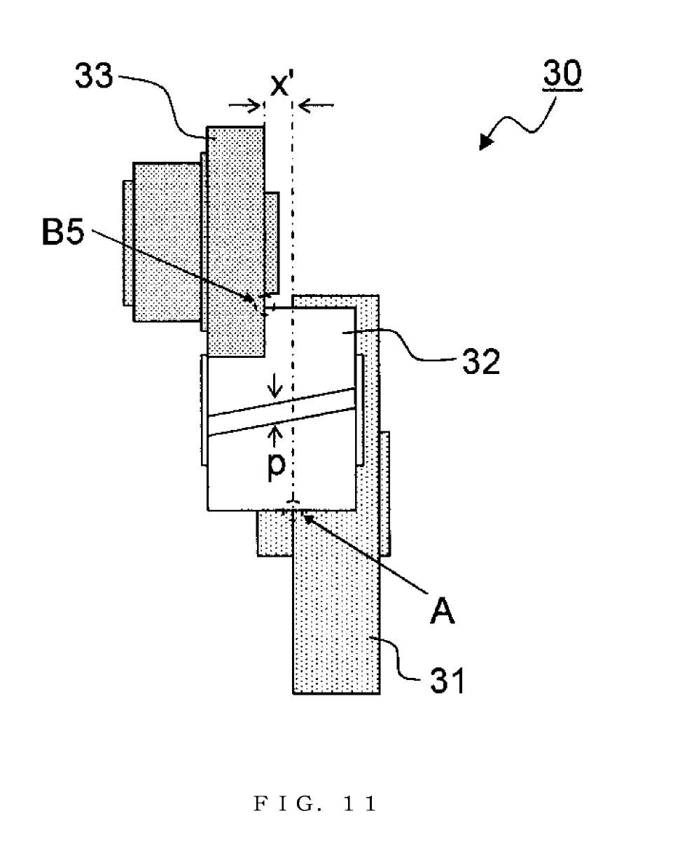

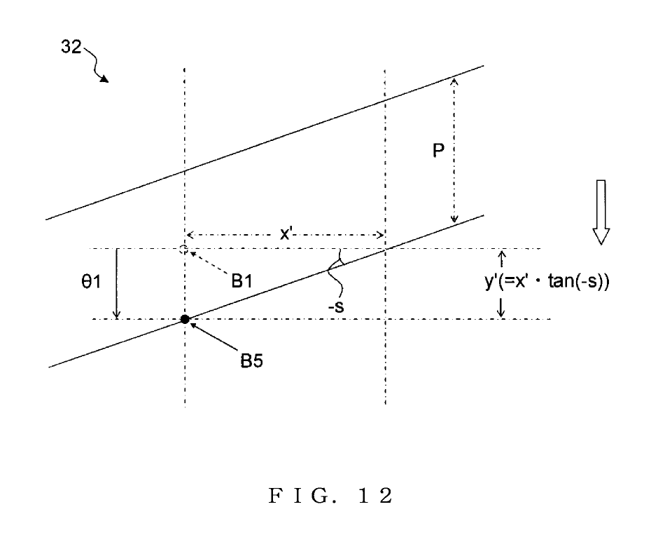

FIG. 11 is a view seen from the upper left (the same direction as that indicated by the arrow in FIG. 8), showing a state of engagement between a drive input gear 31 and a drive output gear 33 with respect to an idle gear 32 in a drive transmission device according to a third embodiment of the present invention. FIG. 12 is a view showing an engagement position in a thrust direction of an engagement point between the idle gear 32 and the drive output gear 33 of FIG. 11. Constituent elements common to those of FIGS. 9 and 10 are designated by common reference numerals, and a duplicate description is omitted.

In the third embodiment, the drive input gear 31 is comprised of a one-stepped helical gear with 32 teeth, a pressure angle of 14.5 degrees, and right torsion; and the drive output gear 33 is comprised of a one-stepped helical gear with 18 teeth, a pressure angle of 14.5 degrees, and right torsion. An idle gear 32 is comprised of a one-stepped gear made of 16 teeth, a pressure angle of 14.5 degrees, and left torsion. A diameter of a pitch circle of the idle gear 32 is set to R (13 mm herein). In addition, a torsional angle of the idle gear 32 is set to −s (−15 degrees herein).

In addition, as shown in FIG. 11, an engagement point between the drive input gear 31 and the idle gear 32 has been defined as A: an engagement point between the idle gear 32 and the drive output gear 33 has been defined as B5, and an interval between the engagement point A and the engagement point B5 in the thrust direction has been defined as x′. Other constituent elements are identical to those of the first and second embodiments, and thus, a duplicate description is omitted. For the sake of simplicity of explanation, a circumferential face of the idle gear 32 is assumed to be flattened.

As shown in FIG. 12, and assuming that the idle gear 32 is a one-stepped spur-tooth gear (see FIG. 5), an interval between an engagement position between the drive input gear 31 and the idle gear 32 and an engagement position between the idle gear 32 and the drive output gear 33 has been adjusted so that an angle in the circumferential direction between the engagement point B1 and the engagement point B5 becomes θ1. In other word, the interval x′ between the engagement point A and the engagement point B5 has been adjusted so that a displacement quantity y′=x′*tan (−s) in the circumferential direction between the engagement point B1 and the engagement point B5 is equal to θ1.

In this manner, an angle formed by the engagement point A and the engagement point B5 can be made substantially identical to the disposition angle α. Therefore, even though the disposition angle α of the drive input gear 31, the idle gear 32, and the drive output gear 33 is fixed and its positional relationship cannot be changed, the idle gear 32 can be formed according to the disposition angle α, thus making it possible to eliminate engagement between gears and reduce vibration.

In addition, in the first, second, and third embodiments, the drive transmission device 30 was comprised of: the drive input gear 31 disposed at image forming portions Pa to Pd, for driving photosensitive drums 1a to 1d; the idle gear 32 for driving the development roller 22 and the magnetic roller 23; and the drive output gear 33. This leads to reduced vibration between gears as well as lessened image non-uniformity such as image density change. The present embodiments find particular application when the drive transmission device 30 is applied to a gear with a small number of teeth in which vibration or rotation non-uniformity is prone to occur. The improved gear is effective when employed at the image forming portions Pa to Pd.

Further, while the first, second, and third embodiments described that the drive accepted by the drive input gear 31 is transmitted to the idle gear 32 and the drive output gear 33, the drive accepted by one of the idle gear 32 and the drive output gear 33 can be adapted to be transmitted to another gear and the drive input gear 31 as long as it is possible to transmit a drive between the idle gear 32 and the drive output gear 33 at a moment when a drive is transmitted between the drive input gear 31 and the idle gear 32.

Furthermore, the present invention is not limitated to the above-described embodiments, and various modifications can occur without departing from the spirit of the invention. For example, while the embodiments described the drive transmission device 30 applied to the photosensitive drums 1a to 1d and development devices 3a to 3d, the gear configuration of the drive transmission device 30 of the present invention is not limitated thereto in particular, and is applicable to other combinations of three or more coupled gears. If four or more gears exist, the present invention is applicable to any three successively coupled gears.

Moreover, while the embodiments introduced a tandem-type image forming apparatus of a direct transfer system for color printing as an example, the present invention is applicable to other image forming apparatuses, and is not limitated thereto in particular. For example, it is also applicable to a tandem-type image forming apparatus of an intermediate transfer system, a color copying machine, a monochrome printer or a monochrome copying machine for monochrome printing, etc. Further, it is also applicable to drive transmission devices of precision instruments or electronic devices other than image forming apparatuses.

What is claimed is:

1. A drive transmission device for transmitting a drive through a gear train, said device comprising:
a first gear;
a second gear coupled with the first gear; and
a third gear coupled with the second gear, wherein:
the first, second, and third gears are disposed in a predetermined positional relationship, with each of the first, second and third gears having a respective rotational axis;
the second gear has a first gear portion coupled with the first gear at a first engagement point and a second gear portion coupled with the third gear at a second engagement point, wherein the first gear portion and second gear portion coaxially integrally rotate with one another; and
a phase angle formed between the first engagement point, the rotational axis of the second gear, and the second engagement point is substantially identical to a fixed angle formed by centerlines drawn between the rotational axis of the second gear and the rotational axes of the first and third gears.

2. The drive transmission device according to claim 1, wherein:
the second gear is a two-stepped gear comprised of the first gear portion and the second gear portion.

3. The drive transmission device according to claim 2, wherein:
the first gear portion and the second gear portion are comprised of a same type of gear.

4. The drive transmission device according to claim 2, wherein:
the second gear is resin-based, and the first gear portion and the second gear portion are integrally molded with a predetermined phase difference with respect to a circumferential direction.

5. The drive transmission device according to claim 1, wherein:
the first, second, and third gears comprise helical gears; and
the phase in the circumferential direction of the first and second gear portions is adjusted based upon an engagement position between the first gear and the first gear portion of the second gear in a thrust direction and an engagement position between the second gear portion of the second gear and the third gear.

6. The drive transmission device according to claim 1, wherein the phase angle is adjusted during manufacture to be substantially identical to the fixed angle.

7. The drive transmission device according to claim 1, wherein the phase angle is designed to be substantially identical to the fixed angle, and wherein the first gear portion and the second gear portion are integrally molded to have the designed phase angle.

8. The drive transmission device according to claim 1, wherein:
the first, second, and third gears are disposed in a development device for feeding toner to an electrostatic latent image formed on an image carrier;
the first gear is an input gear to which a drive force from a predetermined drive source is input;
the second gear is an idle gear for transmitting rotation of the first gear to the third gear; and
the third gear is a drive output gear for rotating a toner feed member in the development device.

9. A development device arranged in an image forming apparatus, for feeding toner to an electrostatic latent image formed on an image carrier, the development device comprising the drive transmission device according to claim 1.

10. An image forming apparatus, comprising the development device according to claim 9.

11. A drive transmission device for transmitting a drive through a gear train, said device comprising:
a first gear;
a second gear coupled with the first gear; and
a third gear coupled with the second gear, wherein:
the first, second, and third gears are disposed in a predetermined positional relationship, with each of the first, second and third gears having a respective rotational axis;
the second gear comprises a helical one-stepped gear;
the second gear has a first gear portion coupled with the first gear at a first engagement point and a second gear portion coupled with the third gear at a second engagement point;
the first gear portion and second gear portion coaxially integrally rotate with one another;
an interval in a thrust direction exists between the first engagement position and the second engagement position; and
a phase angle formed between the first engagement point, the rotational axis of the second gear, and the second engagement point is substantially identical to a fixed angle formed by centerlines drawn between the rotational axis of the second gear and the rotational axes of the first and third gears.

12. The drive transmission device according to claim 11, wherein:
the first, second, and third gears are disposed in a development device for feeding toner to an electrostatic latent image formed on an image carrier;
the first gear is an input gear to which a drive force from a predetermined drive source is input;
the second gear is an idle gear for transmitting rotation of the first gear to the third gear; and
the third gear is a drive output gear for rotating a toner feed member in the development device.

13. A development device arranged in an image forming apparatus, for feeding toner to an electrostatic latent image formed on an image carrier, the development device comprising the drive transmission device according to claim 11.

14. An image forming apparatus, comprising the development device according to claim 13.

15. A method for coupling gears in a drive transmission device having a first gear, a second gear, and a third gear disposed in a predetermined positional relationship, a first portion of the second gear being coupled to the first gear at a first engagement point and a second portion of the second gear being coupled to the third gear at a second engagement point, the method comprising:
adjusting a phase in a circumferential direction of the first gear portion and the second gear portion so that an angle formed between the first engagement point, a rotational axis of the second gear, and the second engagement point is substantially identical to a fixed angle formed by centerlines drawn between the rotational axis of the second gear and the rotational axes of the first and the third gears.

16. The method of claim 15, wherein at least two of the first, second, and third gears comprise helical gears, and wherein adjusting the phase includes adjusting to compensate for an interval in a thrust direction that exists between the first engagement position and the second engagement position.

17. The method of claim 15, wherein the phase angle is adjusted during manufacture to be substantially identical to the fixed angle.
